(19) United States
(12) Patent Application Publication
(10) Pub. No.: US 2021/0258430 A1
(43) Pub. Date: Aug. 19, 2021

(54) 5G Slice Pricing Function

(71) Applicant: Parallel Wireless, Inc., Nashua, NH (US)

(72) Inventor: Michael Y. Saji, Brookline, MA (US)

(21) Appl. No.: 17/157,998

(22) Filed: Jan. 25, 2021

Related U.S. Application Data
(60) Provisional application No. 62/965,436, filed on Jan. 24, 2020.

(51) Int. Cl. H04M 15/00

(52) U.S. Cl. CPC H04M 15/60

(57) ABSTRACT

A method for providing Radio Access Network (RAN) slice pricing is described. In one embodiment, the method includes capturing costs associated with a particular pairing of a particular user to a particular slice using weighted values configurable by an operator; and creating and deleting network slices in accordance with a pricing function associated with the captured costs for a particular user for a particular slice.

### CROSS-REFERENCE TO RELATED APPLICATIONS

This application claims priority under 35 U.S.C. § 119(e) to U.S. Provisional Pat. App. No. 62/965,436, entitled “5G Slice Pricing Function” and filed Jan. 24, 2020. The present application hereby incorporates by reference each of: U.S. patent application Ser. No. 17/146,492, “Fine-Granularity RAN Slicing Control,” filed Jan. 11, 2021; U.S. Provisional Patent Application No. 62/959,447; U.S. Pat. App. Pub. Nos. US20110044285, US20140241316; WO Pat. App. Pub. No. WO2013145592A1; EP Pat. App. Pub. No. EP2773151A1; U.S. Pat. No. 8,879,416, “Heterogeneous Mesh Network and Multi-RAT Node Used Therein,” filed May 8, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/777,246, “Methods of Enabling Base Station Functionality in a User Equipment,” filed Sep. 15, 2016; U.S. patent application Ser. No. 14/289,821, “Method of Connecting Security Gateway to Mesh Network,” filed May 29, 2014; U.S. patent application Ser. No. 14/642,544, “Federated X2 Gateway,” filed Mar. 9, 2015; U.S. patent application Ser. No. 14/711,293, “Multi-Egress Backhaul,” filed May 13, 2015; U.S. Pat. App. No. 62/375,341, “S2 Proxy for Multi-Architecture Virtualization,” filed Aug. 15, 2016; U.S. patent application Ser. No. 15/132,229, “MaxMesh: Mesh Backhaul Routing,” filed Apr. 18, 2016, each in its entirety for all purposes, having attorney docket numbers PWS-71700US01, 71710US01, 71717US01, 71721US01, 71756US01, 71762US01, 71819US00, and 71820US01, respectively. This application also hereby incorporates by reference in their entirety each of the following U.S. Pat. applications or Pat. App. Publications: US20150098387A1 (PWS-71731US01); US20170055186A1 (PWS-71815US01); US20170273134A1 (PWS-71850US01); US20170272330A1 (PWS-71850US02); and Ser. No. 15/713,584 (PWS-71850US03). This application also hereby incorporates by reference in their entirety U.S. patent application Ser. No. 16/424,479, “5G Interoperability Architecture,” filed May 28, 2019; and U.S. Provisional Pat. Application No. 62/804,209, “5G Native Architecture,” filed Feb. 11, 2019.

### BACKGROUND

5G is the next generation Mobile Communication technology following the 4G/LTE. 3GPP has been working on defining the standards for 5G as part of 3GPP Rel 15 and 16. Starting 1G and then followed by 2G, 3G and 4G, each generation has the laid the foundation for the next generation in order to cater to newer use cases and verticals. 4G was the first generation that introduced flat architecture with all-IP architecture. 4G enabled and flourished several new applications and use case. 5G is going to be not just about higher data rates but about total user experience and is going to cater to several new enterprise use cases like Industrial automation, Connected Cars, Massive IOT and others. This will help operators to go after new revenue opportunities.

Launching 5G network will need significant investment as it will need RAN and Packet Core upgrade. 3GPP has defined a new 5G NR and new 5G Core. Eventually all the operators will want to head towards a complete 5G network coverage with the new 5G Standalone Core, given the several new features and capabilities that the new 5G Standalone network brings in. But given the significant cost involved, 3GPP has defined number of different intermediate solutions that can provide gradual migration from current 4G network to the eventual native 5G network.

### SUMMARY

As we are nearing 2020, the standards for 5G are being finalized. 5G, the 3GPP version of ITU IMT-2020 is the main and only contender for the next generation of mobile technology. What is obvious to everyone is that 5G will be a natural evolution from 4G and will drive the ecosystem innovation to deliver enhanced customer experience while extending 4G network investments.

Parallel Wireless HetNet Gateway (HNG) enables a 5G ready architecture which is available to be deployed today. Enhancements to the HNG will allow a Non-standalone (NSA) deployment with LTE and 5G NR connected to EPC. With the availability of 5G Core (5GC), HNG will enable different 5G deployment options seamlessly, thereby reducing the complexity, Capex & Opex, from the operator.

A wireless network system is described. In one embodiment the system includes at least one of a Non-Stand-Alone (NSA) base station and a Stand-Alone (SA) base station and a 5G enhanced HetNet Gateway (HNG) in communication with at least one of the NSA base station and the SA base station, the 5G enhanced HNG including interfaces for any G base station and interfaces for any core network. The system further includes a core network in communication with the 5G enhanced HNG, the core network including at least one of an Evolved Packet Core (EPC) and a 5G Core (5GC) and wherein the 5G enhanced HNG abstracts core functionality for EPC and for the 5GC, thereby providing distributed core functionality.

### BRIEF DESCRIPTION OF THE DRAWINGS

FIG. 1 is a schematic overview of network slicing, in accordance with some embodiments.

FIG. 2 is a call flow showing network slice selection, in accordance with some embodiments.

FIG. 3 is a schematic overview of end to end network slicing with dual slice pairing functions, in accordance with some embodiments.

FIG. 4 is a schematic overview of network slicing using a coordinating gateway, in accordance with some embodiments.

FIG. 5 is a call flow showing RAN access and AMF selection in 5G core, in accordance with some embodiments.

FIG. 6 is a call flow showing end-to-end slicing creation at the core network, in accordance with some embodiments.

FIG. 7 is a diagram showing Radio and RAN slice selection, in accordance with some embodiments.

FIG. 8 is a schematic diagram of allocation of dynamic numerology, in accordance with some embodiments.

FIG. 9 is a diagram showing joint network slicing and mobile edge computing, in accordance with some embodiments.

FIG. 10 is a diagram showing RAN slicing—dynamic Inter-RAT switching, in accordance with some embodiments.

FIG. 11 is a diagram showing slicing functions, in accordance with some embodiments.

FIG. 12 is a diagram showing the separation between NC-RAN and 5GC, in accordance with some embodiments.

FIG. 13 is a schematic overview of network slicing, in accordance with some embodiments.

FIG. 14 is a diagram showing 5G native architecture, in accordance with some embodiments.

FIG. 15 is a flow diagram of a method for creating or deleting network slicing in accordance with a pricing function, in accordance with some embodiments.

FIG. 16 is a schematic diagram of a multi-RAT core network, in accordance with some embodiments.

FIG. 17 is a system diagram of an enhanced base station, in accordance with some embodiments.

FIG. 18 is a system diagram of a coordinating server, in accordance with some embodiments.

### DETAILED DESCRIPTION

As the future of 5G is still being defined, there is much uncertainty around what 5G will actually be once it comes to fruition. If the main goal of 5G is to improve people's lives, the development of 5G should consider the various use cases for 5G. Additionally, 5G networks should seek to address the challenges faced by current 2G, 3G, 4G network architectures.

Varying network maturity in different regions requires a solution that can address older (2G, 3G, 4G) generation technologies while managing future (5G) networks—what will work for the more advanced market likely won't be a good option for less developed markets. One example of this is the Indian market, which still largely uses 3G networks and is still making investments into 4G. If 5G is set to be another air interface introduced within the next five years, does this mean that networks in India and other countries with older generation networks will have to simply skip over 4G. Another example of this is in Western European markets where 4G LTE investments are projected to increase dramatically over the next few years.

The defining challenge of the next ten years will be to efficiently deploy and manage networks that are becoming more complex in order to address the challenges of increasing data usage and higher density. The issue with managing these networks is that they comprise of several different technologies and air interfaces.

The HetNet Gateway (HNG) plays a central role in orchestrating the slicing functionality in 4G, and in future, in the 5G networks.

In 5G network communication infrastructure is not just continued to mobile voice/text communication, it is now segregated and very diversified to different services like Industrial IoT, Smart home domestic IoT, Low latency Medical communication, high bandwidth mobile broadband etc. And each of these services require different data behavior and QoS from network infrastructure.

In 5G each network node is equipped with special features to serve the purpose of one or multiple services and the kind of service supported by a particular node is defined in NSSF(Network Slice Selection Function). For any particular service request from UE, is served by a set of network entities associated with that Service and called a slice.

While the description details the use of 5G, it is not limited to only 5G. In some embodiments, signals are routed through the HNG and slice pairing is performed (2G, 3G, 4G) to an underlying slice in the core network using 5G slice protocols.

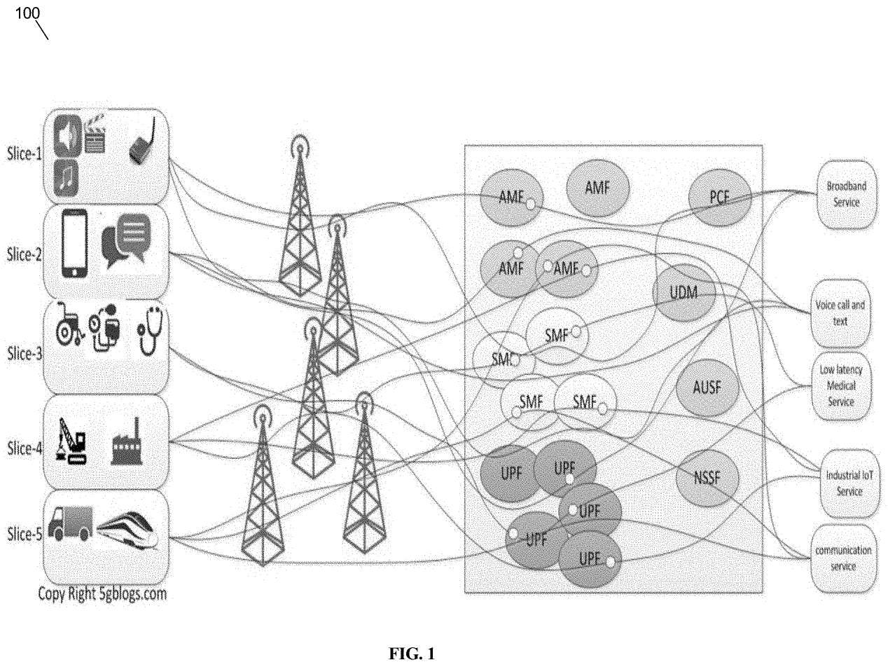

FIG. 1 is a schematic overview 100 of network slicing.

Network Slice configuration Information can have multiple NSSAI Each PLMN can have at most one configured NSSAI

Each NSSAI has multiple S-NSSAI slices.

Each S-NSSAI slice has multiple DNNs configured.

A configured NSSAI can be configured by a serving PLMN or default NSSAI configured by HPLMN.

If Serving PLMN doesn't have specific configured PLMN then it uses default configured NSSAI from HPLMN.

UE is pre-configured/provisioned by signaling message with default configured NSSAI by HPLMN.

UE is only configured with a set of subscribed S-NSSAIs out of the default configured NSSAI, which is a subset of the S-NSSAIs configured inside default configured NSSAI in HPLMN.

Allowed S-NSSA is provided to the UE can have values, which are not served by Serving PLMN, in that case Serving PLMN updates the allowed S-NSSAI list with mapping to corresponding S-NSSAI of the HPLMN.

S-NSSAI and its Structure

Each Slice is identified by S-NSSAI (single network slice selection identifier).

Includes an SST and an SD.

SST is required value where was SD is optional SST refer to expected behavior of the slice.

SD is optional and differentiates among multiple slices with same SST.

UE during Registration and PDU session Establishment sends S-NSSAI value and optionally HPLMN NSSAI value, if in visiting area.

The requested NSSAI signaled by UE to network allows the network to select appropriate serving AMF, Network slice and network slice instance.

Based on the subscription data, one UE can have subscription to multiple S-NSSAIs and one of them can be marked as default S-NSSAI.

Subscription information for each S-NSSAI may have multiple DNN and one of them is default DNN.

Services Provided by NSSF

| | | Reference in |
|---|---|---|
| | | TS 23.502 |
| Service Name | Description | [3] |
| Nnssf_NSSelection | Provides the requested | 5.2.16.2 |
| | Network Slice information | |
| | to the Requester. | |
| Nnssf_NSSAIAvailability | Provides NF consumer | 5.2.16.3 |
| | on the availability of | |
| | S-NSSAIs on a per TA basis. | |

Nnssf_NSSelection_Get Service Operation

May be invoked during Registration, for serving AMF selection and re-allocation. PDU session establishment procedure, for SMF selection.

UE configuration update procedure, to update allowed S-NNAIs to UEs in current serving PLMN.

Nnssf_NSSAIAvailability

Nnssf_NSSAIAvailability_Update: In this process, AMF updates NSSF with S-NSSA is supported by AMF per TA and gets back availability of S-NSSA is for each TA.

Nnssf_NSSAIAvailability_Notify: AMF notify NSSF with restricted S-NSSAIs per TA using this procedure.

AMF Re-Allocation Procedure

During UE registration procedure, if AMF doesn't support one or more requested S-NSSAIs which is allowed by SPLMN/HPLMN then it request NSSF to provide the appropriate AMF to redirect the registration request from UE.

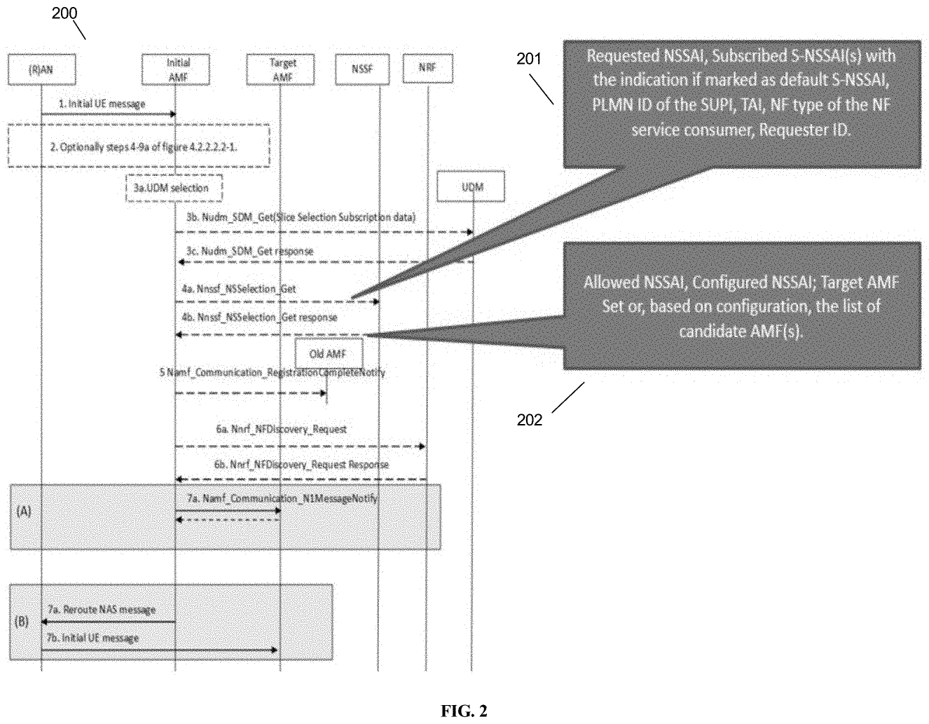

FIG. 2 is a call flow 200 showing network slice selection during handover, in accordance with some embodiments. At step 201, a requested NSSAI is requested from the initial AMF to the target AMF to the slice selection function in the target network. Then at step 202 the allowed network slice is set up. This is considered to be possible across RATs as well, in some embodiments, utilizing the core network abstraction of the HNG.

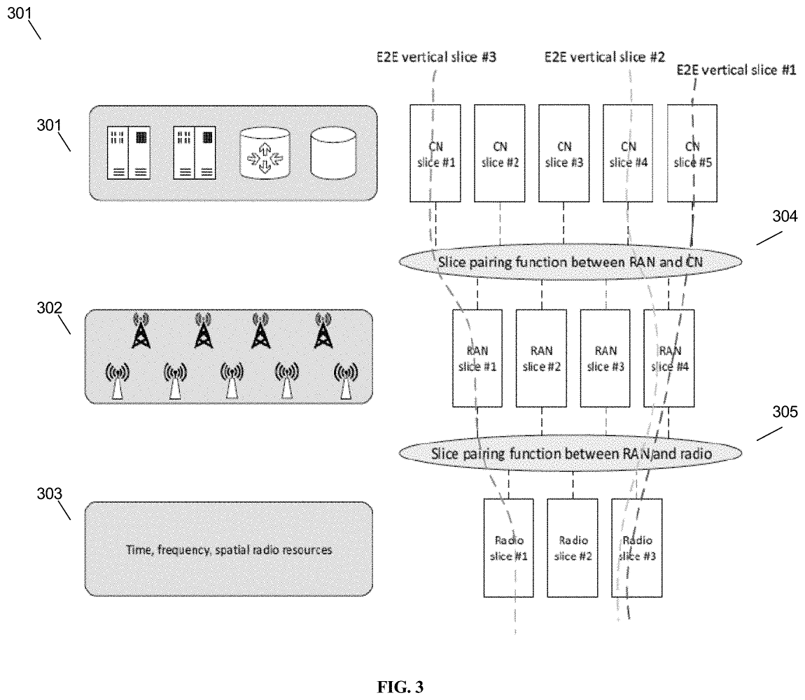

FIG. 3 is a schematic overview of end to end network slicing with dual slice pairing functions, in accordance with some embodiments. This is a diagram showing the slicing in a vertical orientation. Core network 301, RAN nodes 302, and radio resources 303 are shown. As well, end to end vertical slices are shown. Note that a slice pairing function between RAN and CN 304 is placed between the RAN and the core, and a slice pairing function between the RAN and the radio 305 is also shown. A coordinating node or HNG can provide both 304 and 305 pairing functions and may be located at an appropriate place in the network, e.g., at the edge of the network.

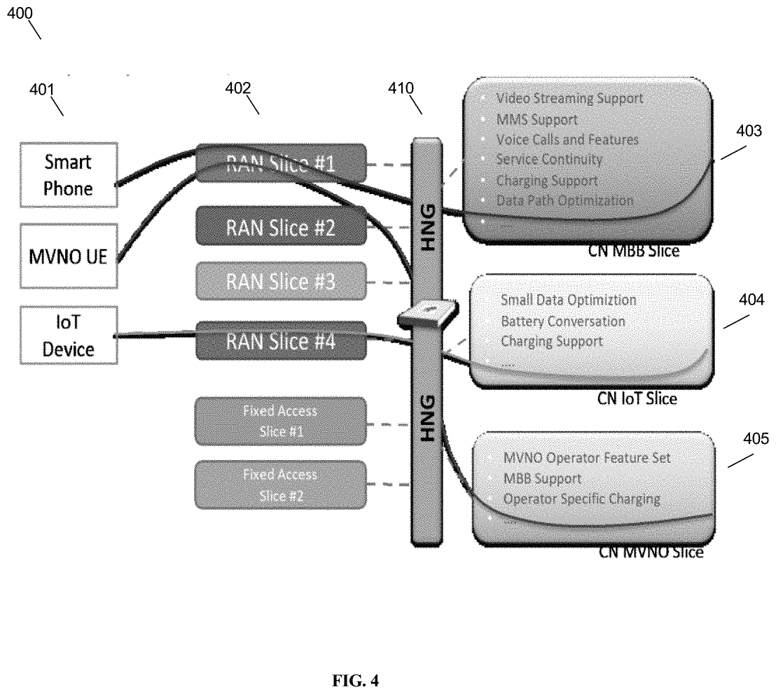

FIG. 4 is a schematic overview of network slicing using a coordinating gateway, in accordance with some embodiments. User devices 401 (smartphone, MVNO UE, IoT device) utilize various combinations of RAN slices 402 and core slices 403 (MBB), 404 (IoT), 405 (MVNO). (The MVNO slice is a slice that provides network resources that have been paid for by the virtual mobile network operator or MVNO.) Different slices provide different sets of services as listed in the figure. Note that a HNG 410 is providing a coordinating function to match user devices 401, RAN slices 402, and core slices 403, 404, 405.

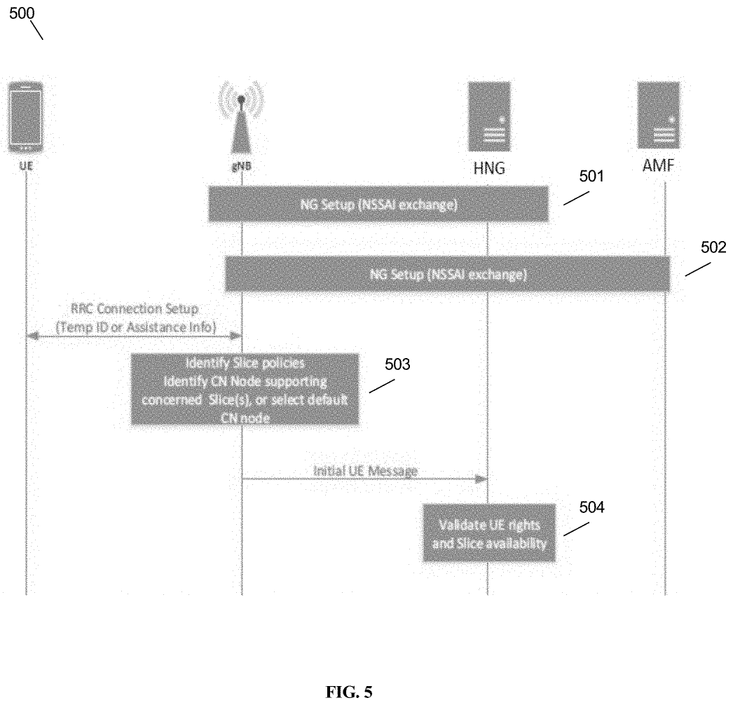

FIG. 5 is a call flow showing RAN access and AMF selection in 5G core, in accordance with some embodiments. NG setup 501 involves the HNG, where an NSSAI is negotiated with the HNG and also then negotiated with the 5GC AMF 502. Once the slice ID is identified, the slice policies, CN resource etc. are identified at the gNB 503, and then when the UE connects to the HNG, the coordinating node validates UE rights 504.

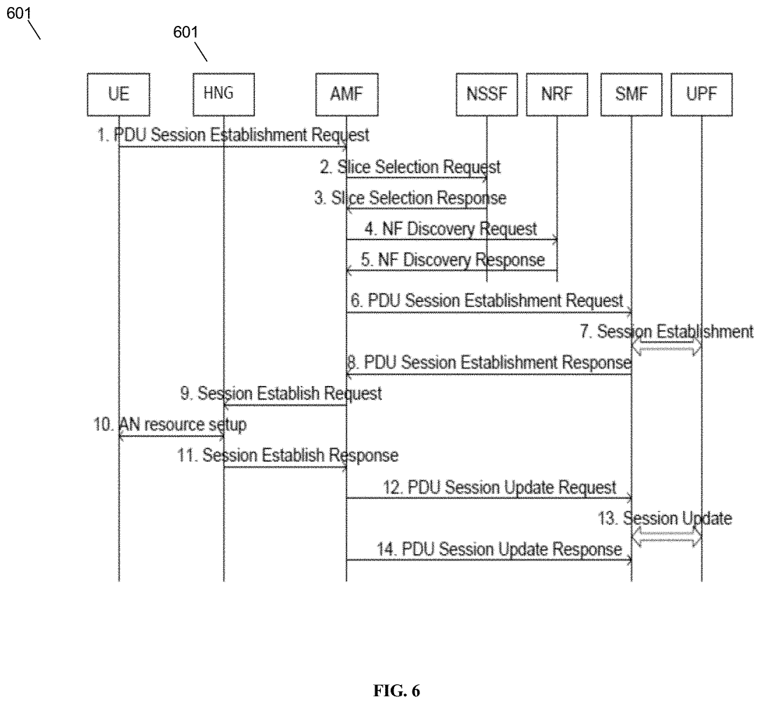

FIG. 6 is a call flow showing end-to-end slicing creation at the core network, in accordance with some embodiments. In the core network the HNG is responsible for resource setup after resources are allocated by the core.

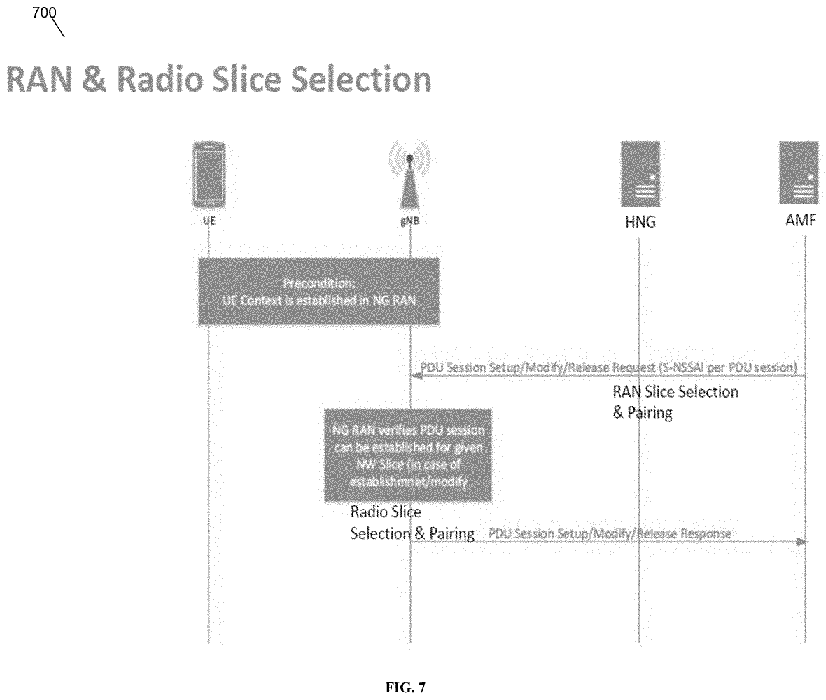

FIG. 7 shows radio and RAN selection 700. RAN and Radio slicing—fine granulrity differentiation control. Dynamically adjusting numerology and pre-emption scheme. Joint RAN slicing and mobile Edge computing. Dynamically pairing with appropriate radio slicing. Dynamic inter-RAT switching. Further RAN-slicing differentiation: dynamic modulation adjustment based on SINR.

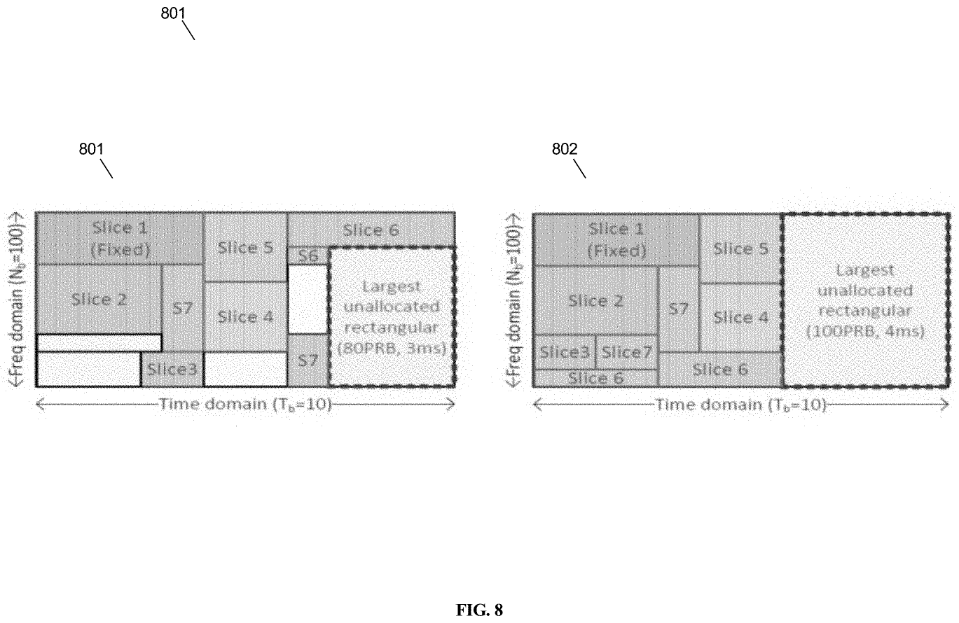

FIG. 8 is a schematic diagram of allocation of dynamic numerology in 5G, in accordance with some embodiments. The HNG (or in some cases the gNB) may perform radio slice selection and may allocate radio resources to provide services to a UE. If the UE requires high bandwidth, a large rectangular block of radio resources may be allocated (for example, to an eMBB slice). The HNG may manage this and may manage this for multiple RATs; alternately the gNB may manage this; alternately the gNB may take on this function for managing multiple RATs as well as 5G. Note that only 5G has a flexible numerology. The use of additional RATs may be understood to be additive to the 5G radio resource domain.

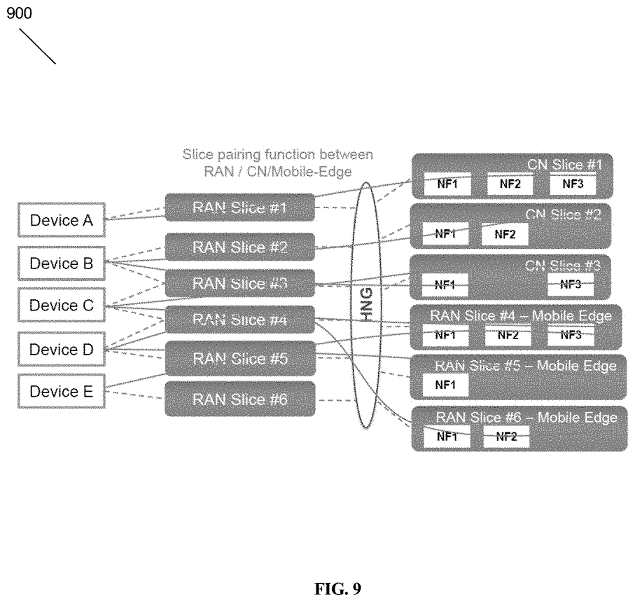

FIG. 9 is a diagram showing joint network slicing and mobile edge computing 900, in accordance with some embodiments.

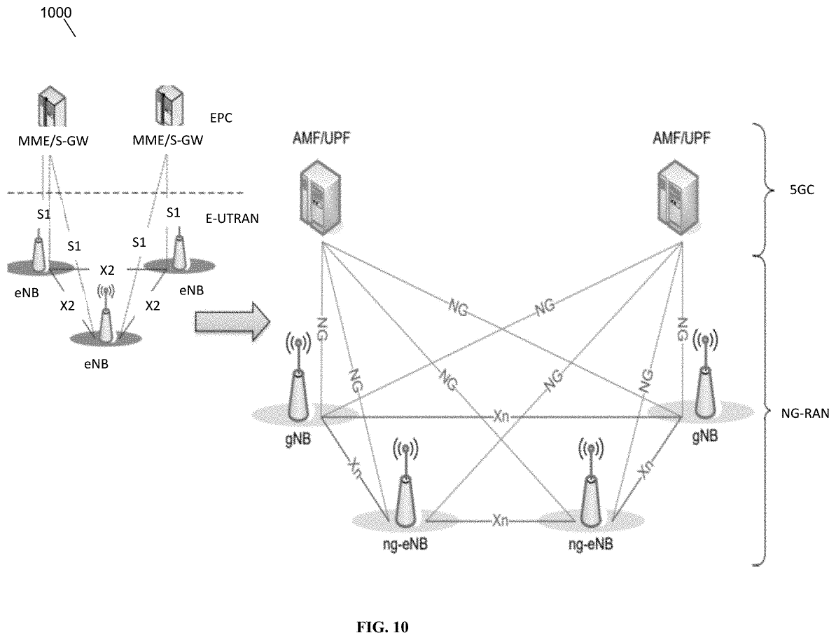

FIG. 10 is a diagram showing RAN slicing—dynamic Inter-RAT switching 1000, in accordance with some embodiments. Radio Slicing Differentiation includes dynamically adjusting transmit power, dynamically adjusting transmit beamforming, and dynamic MIMO scheme selection.

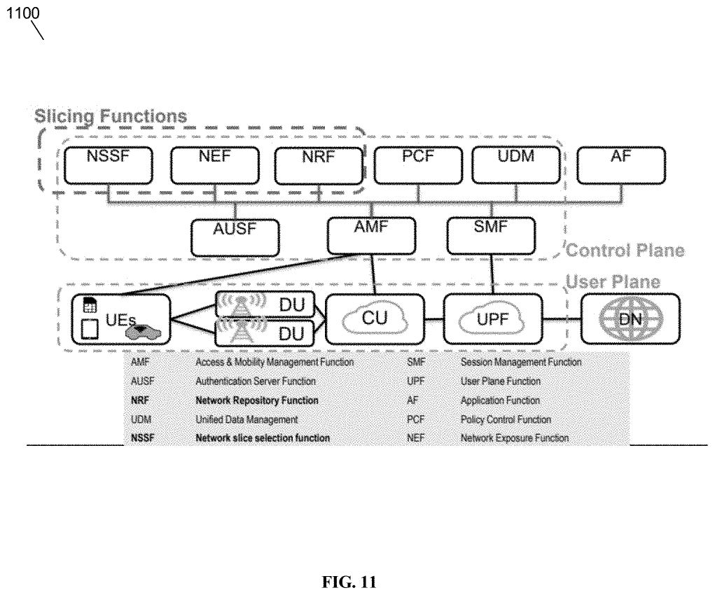

FIG. 11 is a diagram showing slicing functions 1100, in accordance with some embodiments. RAN slicing—dynamic inter-RAT switching includes dynamically adjusting Rat technology. Switching between LTE and NR, or DC if needed. Switching font-end radio to Wi-Fi, if possible. Switching radio to device-2-device, if possible. In all these cases, it is always anchored with 5G core

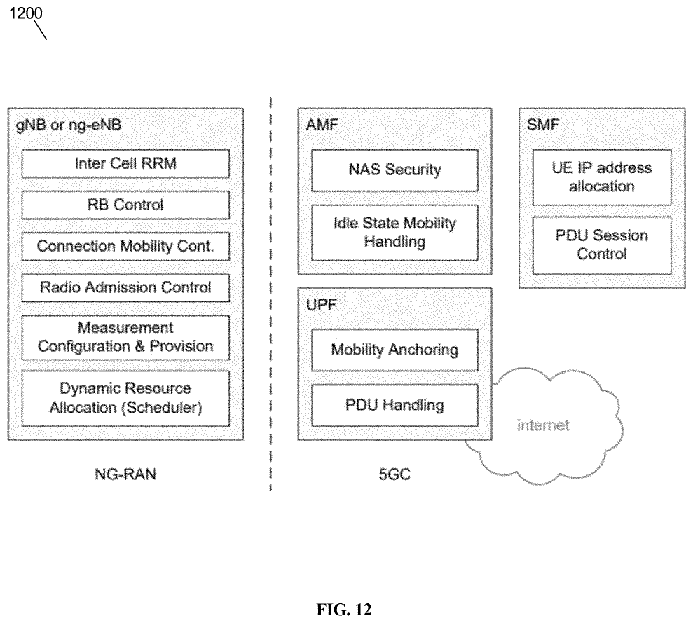

FIG. 12 is a diagram showing the separation between NC-RAN and 5GC 1200, in accordance with some embodiments.

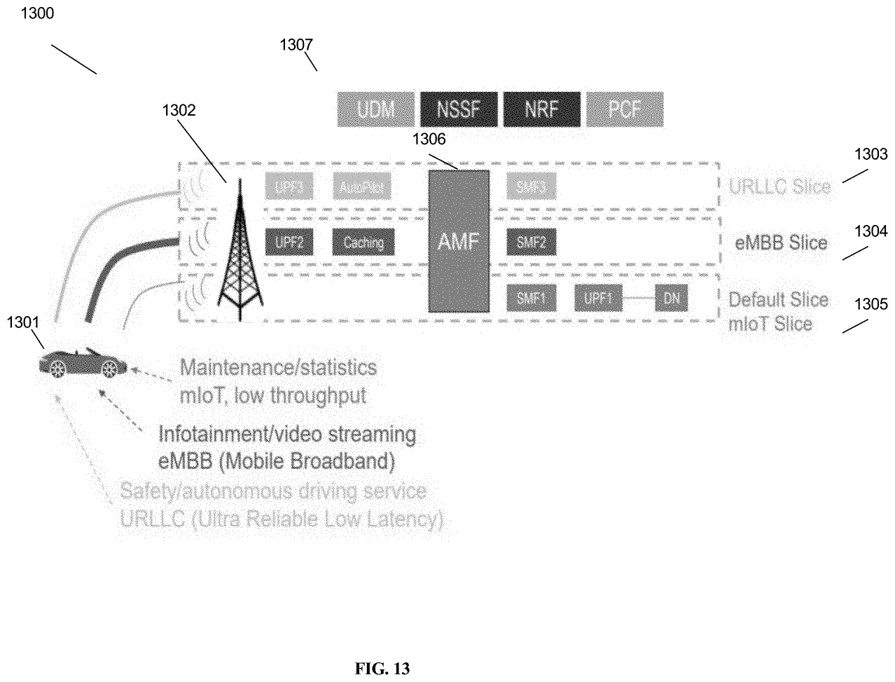

FIG. 13 is a schematic overview of network slicing, in accordance with some embodiments. A car 1301 is shown with multiple network clients, including one client that requires low throughput (machine/Internet of Things or mIoT), one that requires ultra reliable low latency (URLLC), and one that requires video streaming mobile broadband (eMBB). Each of these clients uses a different slice, which includes various network resources deployed end to end, here shown as URLLC slice 1303, eMBB slice 1304, and default slice (mIoT slice) 1305. The different slices provide different guarantees. The slices all utilize and share RAN node 1302. AMF 1306 is part of each slice and is responsible for coordinating the slices, as well as required communication with 5GC 1307.

In slicing, Two pieces RAN slice and Core slice. HNG sits between these—slice pairing function. Take core slice as a given. 5G spec already has a slice pairing fn, it is part of.

Key role of a node between core and edge, such as HNG. Also, key role of HNG in understanding RAN slice. In 4G core, Qi's flows, DSCP, diffserv, MPLS, marking schemes, etc have already been well developed and defined. But the RAN slice, in terms of using these RAN techs to differentiate with fine granularity has not been well defined.

E.g.: 4 g subcarrier spacing numerology is fixed at 15 khz. But in 5G, it can be 15 k, 30 k, 60 k, 120 k. Once you change the numerology on the frequency side, there is a duality on the time side (when you double width on the frees, you are halving the time slot on the time side). So, it follows that, if you have time sensitivity, you want a wide freq numerology, and you can tile these with other blocks. And HNG can construct these tiled slices.

ego: Adaptive beamforming. Use different characteristics of beamforming to tie with RAN slice. Eg: preempting. We define EMBB and also ultrareliable services. Preempting. This can be integrated with RAN slices. Eg: power. If you need ultrareliable service, keep the power on for those antennas. Otherwise turn power on or off as needed, enabling power savings. Eg: spectrum sharing. If you need ultrareliable service, you dedicate the spectrum. Otherwise share spectrum as needed.

The new 5G RAN properties can be enabling schemes for constructing a new semantics of RAN slice. The standard does not define how to make these RAN slices happen. Heterogeneity of our resources. Stack from one vendor. Radio from another vendor. We add the key innovation with the network slice manager. Don't forget the inter-RAT aspect as well.

One general scheme for EMBB (high bitrate), one general scheme for ultrareliable/low latency, one general scheme for IoT. Rely on UE feedback, RAN condition, UE signal strength/quality (e.g. SINR). eg, 256 QAM does not work for low SINR UE [0084] Consider UE feedback and also other UEs' feedback [0085] Periodically perform a rebalancing for all UEs. This would happen both at a long period and also at an intermediate period at the HNG; could be fixed. Could be tied into the policies. eg, streaming. Assign certain policies to normal streaming, or preferred streaming due to contractual obligations. eg, low latency services. Can assign different policies to different company's cars or different hospital's surgeons.

The network slicing functionality contains access network slices, core network slices and the selection function in the HNG that connects these slices into a complete network slice comprised of both the access network and the core network. The selection function routes communications to an appropriate CN slice that is tailored to provide specific services. The criteria of defining the access slices and CN slices include the need to meet different service/applications requirements and to meet different communication requirements.

Each core network slice is built from a set of network functions (NFs). An important factor in slicing is that some NFs can be used across multiple slices, while other NFs are tailored to a specific slice.

The new 5G system is service-based architecture (SBA). This means that wherever suitable the architecture elements are defined as network functions that offer their services via interfaces of a common framework to any network functions that are permitted to make use of these provided services. NRF or Network repository functions allow every network function to discover the services offered by other network functions. This architecture model, which further adopts principles like modularity, reusability and self-containment of network functions, is chosen to enable deployments to take advantage of the latest virtualization and software technologies.

To enable early adopters of 5G technology to launch commercial services with New Radio (NR), the NSA approach allows to use an existing 4G Mobile Core Network and ease the transition to the Next Generation Core (NGC) once it is available.

Multiple-Access/Multiple-Service Networks: In addition to the network supporting both 4G and 5G RAN, the 5G Core Network will have a deeper integration of access technologies like Wi-Fi and Fixed Access. The main vision of 5G core networks is to have common control and user planes regardless of the access type(s) being used. While this requirement adds complexity to the overall solution and its deployment, it grants enormous flexibility for multi-service operators.

End to End Network Slicing: in order to support the different type of services shown above and over a common network, the network resources —all the way from the RAN to the Internet Access—will include the ability to have End-to-End ‘slices’, each of them with their own performance characteristics, isolated from the other slices. Each slice will have a different QoS, security considerations, latency characteristics, Inline Services, etc. For example, the network characteristics for a Best Effort IoT slice will differ significantly from a high-end Enterprise slice (think throughput, latency, always-on vs intermittent connection, data volume, voice vs data-only)

Fully virtualized Next Generation core (NGC): the transformation on mobile networks initiated with virtualization of the mobile core in 4G (away from chassis/proprietary hardware), has become a pillar of 5G networks. Requirements in this area go beyond the mere use of VM-based Virtual Network Functions (VNF), but as an evolution towards cloud-native architectures. The IT model of deployment (as cloud-giants like Amazon have done for e-commerce) is being applied to the Telecom industry. Automation and Orchestration of such virtualized solutions is a necessity as well. The ability to separate Control and User planes is also a basic requirement of 5G networks.

5G Enhanced HetNet Gateway (HNG)

As discussed earlier, HNG will play a key role in the 5G network architecture to simplify the deployment of 5G network and the 5G migration strategy. If slice ID is globally unique, can do multi- and inter-rat slicing. Note that slice pairing cold be done without HNG.

Slice ID is NSSAI, assigned by NSSAF, could be multi-RAT also.

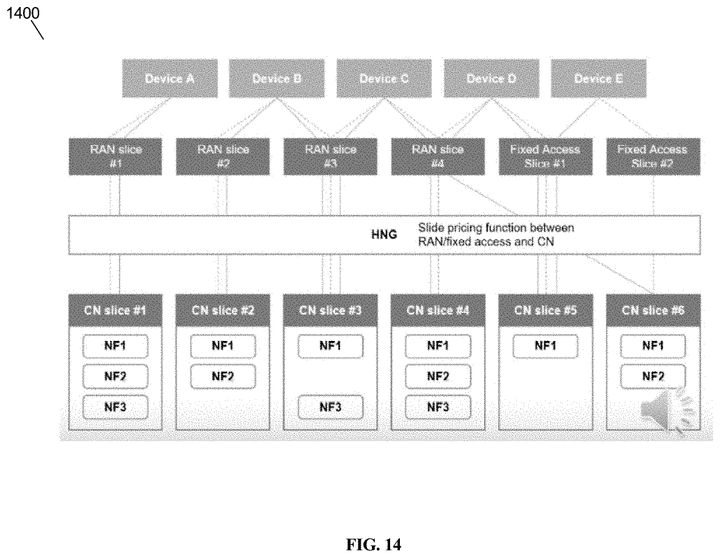

FIG. 14 is a diagram showing 5G native architecture 1500, in accordance with some embodiments. In FIG. 14, a slice pricing function is situated between RAN/fixed access and a core network, such that RAN slices and fixed access slices are allocated among user devices, and the RAN slices are paired with core network slices. Network function virtualizations at the core are also shown. The pairing is performed using a slice pricing function, such that a pricing function is associated with the pairing between the RAN slice and the core network slice, as shown in the following figure.

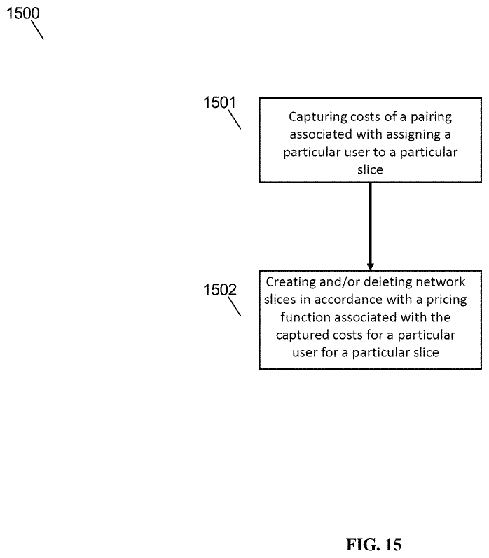

FIG. 15 is a flow diagram of a method 1500 for creating or deleting network slicing in accordance with a pricing function, in accordance with some embodiments. At 1501, costs of a pairing associated with assigning a particular user to a particular slice are captured. This entails the use of a pricing function. The pricing function may take into account various needs and costs as described in the following paragraphs. At 1502, network slices are created and/or deleted according to the pricing function in 1501.

The inventors have contemplated the use of a pricing function when performing slice pairing. Slice pairing between the RAN and a core network involves different costs and tradeoffs that result from trading off the needs of certain customers against others, etc., including: between multiple operators that desire to use the same hardware, between users within the same operator network that are assigned different pricing tiers or pricing plans, or between different slices for the same customer that have different needs in terms of latency, bandwidth, or any other metric.

In order to provide efficient use and reuse and sharing of available slices, a pricing function is used, in some embodiments. The costs of a particular pairing (assigning a particular user to a particular slice) are captured using weighted values, including weights given to performance slowdown for other users/slices, overhead required to create and service a slice, bandwidth and latency that are reserved or used up when a slice is paired, cloud service availability, core network service availability, RAN backhaul availability, etc. These weights are configurable by the operator. Creation and deletion of new slices and the associated overhead may also be accommodated in the pricing function, in some embodiments. In operation, an operator may assign weights to enable, for example, rapid creation of new slices without assigning dedicated performance resources to the slices until needed; or dedicated performance resources to each slice by heavily penalizing new slice creation/pairing; etc.

In some embodiments, different RATs could be assigned different slice pricing.

Different pricing algorithms may be used for the pricing function. In some embodiments, dynamic price optimization may be performed by performing analysis of slice pricing data over time, including by using experimentation and active learning, optimization with and without pricing policy constraints, and demand modeling.

The pricing function may be configured to operate where the slice pairing takes place, in order to enable the pricing function to have as much information as possible regarding: availability of overhead for slice creation; available CPU and bandwidth resources; available RAN resources; available spectrum resources; etc., as availability is a factor in assigning a price. When availability is high, pricing can be low; when availability is low, pricing can be more expensive so as to enable more sensitive data to pay a higher slice pairing fee.

In some embodiments, automated bidding by individuals, agents, software policies, etc. can be configured. In some embodiments, QoS/QCI may be integrated into the slice pairing and slice pricing functions. In some embodiments, pricing may be tied to what an end user customer will pay, for example with microtransactions; in other embodiments, pricing may be unitless and may be used by a network operator to enhance performance without charging individual customers directly for slice pairing, e.g., by assigning a certain unitless number of slice pairing credits to each customer that can be used over the course of a month. In some embodiments simulations can be used to generate appropriate weights and starting values.

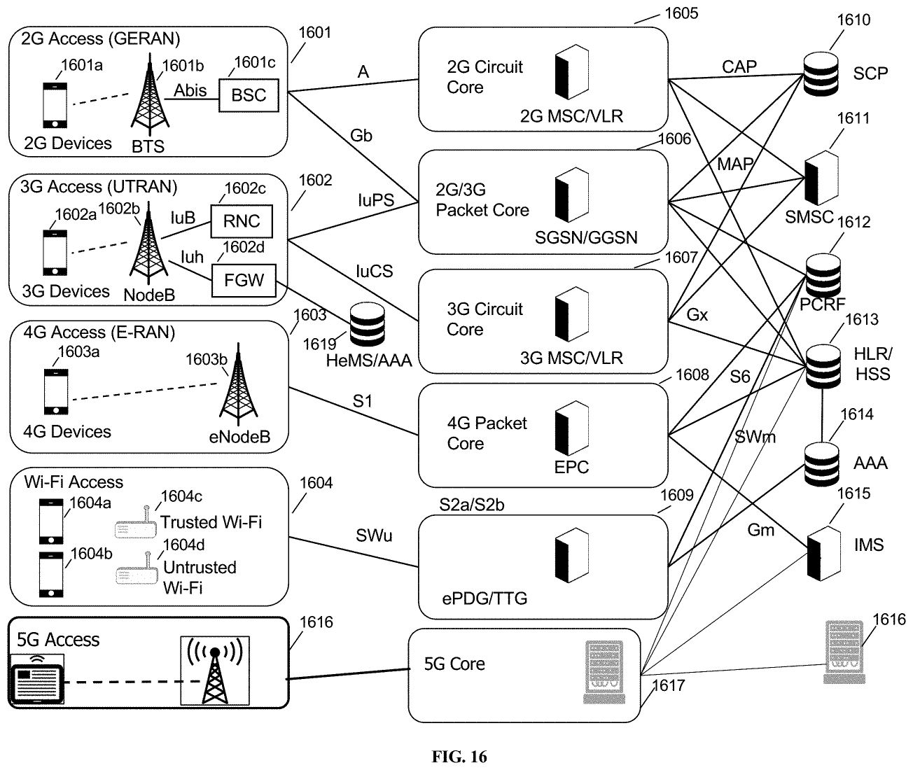

FIG. 16 is a schematic network architecture diagram for 3G and other-G prior art networks. The diagram shows a plurality of “Gs,” including 2G, 3G, 4G, 5G and Wi-Fi. 2G is represented by GERAN 1601, which includes a 2G device 1601a, BTS 1601b, and BSC 1601c. 3G is represented by UTRAN 1602, which includes a 3G UE 1602a, nodeB 1602b, RNC 1602c, and femto gateway (FGW, which in 3GPP namespace is also known as a Home nodeB Gateway or HNBGW) 1602d. 4G is represented by EUTRAN or E-RAN 1603, which includes an LTE UE 1603a and LTE eNodeB 1603b. Wi-Fi is represented by Wi-Fi access network 1604, which includes a trusted Wi-Fi access point 1604c and an untrusted Wi-Fi access point 1604d. The Wi-Fi devices 1604a and 1604b may access either AP 1604c or 1604d. In the current network architecture, each “G” has a core network. 2G circuit core network 1605 includes a 2G MSC/VLR; 2G/3G packet core network 1606 includes an SGSN/GGSN (for EDGE or UMTS packet traffic); 3G circuit core 1607 includes a 3G MSC/VLR; 4G circuit core 1608 includes an evolved packet core (EPC); and in some embodiments the Wi-Fi access network may be connected via an ePDG/TTG using S2a/S2b. Each of these nodes are connected via a number of different protocols and interfaces, as shown, to other, non-“G”-specific network nodes, such as the SCP 1630, the SMSC 1631, PCRF 1632, HLR/HSS 1633, Authentication, Authorization, and Accounting server (AAA) 1634, and IP Multimedia Subsystem (IMS) 1635. An HeMS/AAA 1636 is present in some cases for use by the 3G UTRAN. The diagram is used to indicate schematically the basic functions of each network as known to one of skill in the art, and is not intended to be exhaustive. For example, 5G core 1617 is shown using a single interface to 5G access 1616, although in some cases 5G access can be supported using dual connectivity or via a non-standalone deployment architecture.

Noteworthy is that the RANs 1601, 1602, 1603, 1604 and 1636 rely on specialized core networks 1605, 1606, 1607, 1608, 1609, 1637 but share essential management databases 1630, 1631, 1632, 1633, 1634, 1635, 1638. More specifically, for the 2G GERAN, a BSC 1601c is required for Abis compatibility with BTS 1601b, while for the 3G UTRAN, an RNC 1602c is required for Iub compatibility and an FGW 1602d is required for Iuh compatibility. These core network functions are separate because each RAT uses different methods and techniques. On the right side of the diagram are disparate functions that are shared by each of the separate RAT core networks. These shared functions include, e.g., PCRF policy functions, AAA authentication functions, and the like. Letters on the lines indicate well-defined interfaces and protocols for communication between the identified nodes.

The system may include 5G equipment. 5G networks are digital cellular networks, in which the service area covered by providers is divided into a collection of small geographical areas called cells. Analog signals representing sounds and images are digitized in the phone, converted by an analog to digital converter and transmitted as a stream of bits. All the 5G wireless devices in a cell communicate by radio waves with a local antenna array and low power automated transceiver (transmitter and receiver) in the cell, over frequency channels assigned by the transceiver from a common pool of frequencies, which are reused in geographically separated cells. The local antennas are connected with the telephone network and the Internet by a high bandwidth optical fiber or wireless backhaul connection.

5G uses millimeter waves which have shorter range than microwaves, therefore the cells are limited to smaller size. Millimeter wave antennas are smaller than the large antennas used in previous cellular networks. They are only a few inches (several centimeters) long. Another technique used for increasing the data rate is massive MIMO (multiple-input multiple-output). Each cell will have multiple antennas communicating with the wireless device, received by multiple antennas in the device, thus multiple bitstreams of data will be transmitted simultaneously, in parallel. In a technique called beamforming the base station computer will continuously calculate the best route for radio waves to reach each wireless device, and will organize multiple antennas to work together as phased arrays to create beams of millimeter waves to reach the device.

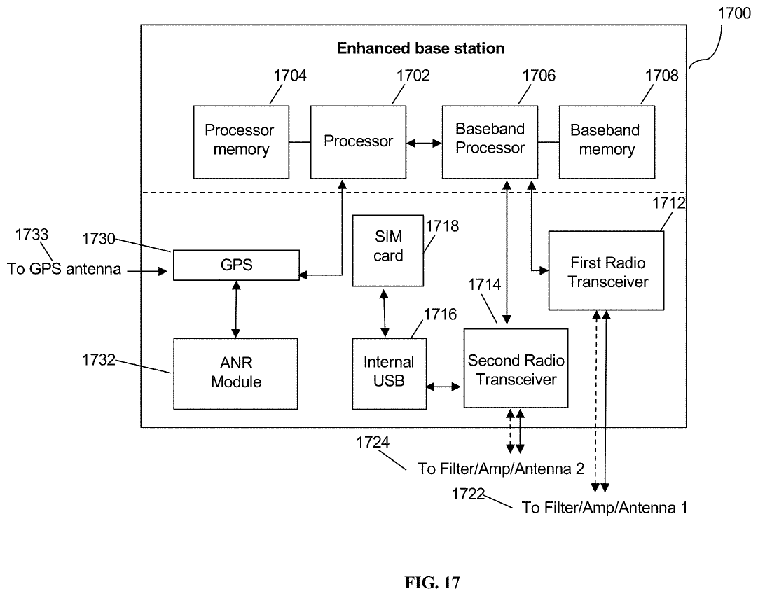

FIG. 17 is an enhanced eNodeB for performing the methods described herein, in accordance with some embodiments. eNodeB 1700 may include processor 1702, processor memory 1704 in communication with the processor, baseband processor 170 19, and baseband processor memory 1708 in communication with the baseband processor. Mesh network node 1700 may also include first radio transceiver 1712 and second radio transceiver 1714, internal universal serial bus (USB) port 171 19, and subscriber information module card (SIM card) 1718 coupled to USB port 171 19. In some embodiments, the second radio transceiver 1714 itself may be coupled to USB port 171 19, and communications from the baseband processor may be passed through USB port 171 19. The second radio transceiver may be used for wirelessly backhauling eNodeB 1700.

Processor 1702 and baseband processor 170 19 are in communication with one another. Processor 1702 may perform routing functions, and may determine if/when a switch in network configuration is needed. Baseband processor 170 19 may generate and receive radio signals for both radio transceivers 1712 and 1714, based on instructions from processor 1702. In some embodiments, processors 1702 and 170 19 may be on the same physical logic board. In other embodiments, they may be on separate logic boards.

Processor 1702 may identify the appropriate network configuration, and may perform routing of packets from one network interface to another accordingly. Processor 1702 may use memory 1704, in particular to store a routing table to be used for routing packets. Baseband processor 170 19 may perform operations to generate the radio frequency signals for transmission or retransmission by both transceivers 1710 and 1712. Baseband processor 170 19 may also perform operations to decode signals received by transceivers 1712 and 1714. Baseband processor 170 19 may use memory 1708 to perform these tasks.

The first radio transceiver 1712 may be a radio transceiver capable of providing LTE eNodeB functionality, and may be capable of higher power and multi-channel OFDMA. The second radio transceiver 1714 may be a radio transceiver capable of providing LTE UE functionality. Both transceivers 1712 and 1714 may be capable of receiving and transmitting on one or more LTE bands. In some embodiments, either or both of transceivers 1712 and 1714 may be capable of providing both LTE eNodeB and LTE UE functionality. Transceiver 1712 may be coupled to processor 1702 via a Peripheral Component Interconnect-Express (PCI-E) bus, and/or via a daughtercard. As transceiver 1714 is for providing LTE UE functionality, in effect emulating a user equipment, it may be connected via the same or different PCI-E bus, or by a USB bus, and may also be coupled to SIM card 1718. First transceiver 1712 may be coupled to first radio frequency (RF) chain (filter, amplifier, antenna) 1722, and second transceiver 1714 may be coupled to second RF chain (filter, amplifier, antenna) 1724.

SIM card 1718 may provide information required for authenticating the simulated UE to the evolved packet core (EPC). When no access to an operator EPC is available, a local EPC may be used, or another local EPC on the network may be used. This information may be stored within the SIM card, and may include one or more of an international mobile equipment identity (IMEI), international mobile subscriber identity (IMSI), or other parameter needed to identify a UE. Special parameters may also be stored in the SIM card or provided by the processor during processing to identify to a target eNodeB that device 1700 is not an ordinary UE but instead is a special UE for providing backhaul to device 1700.

Wired backhaul or wireless backhaul may be used. Wired backhaul may be an Ethernet-based backhaul (including Gigabit Ethernet), or a fiber-optic backhaul connection, or a cable-based backhaul connection, in some embodiments. Additionally, wireless backhaul may be provided in addition to wireless transceivers 1712 and 1714, which may be Wi-Fi 802.11a/b/g/n/ac/ad/ah, Bluetooth, ZigBee, microwave (including line-of-sight microwave), or another wireless backhaul connection. Any of the wired and wireless connections described herein may be used flexibly for either access (providing a network connection to UEs) or backhaul (providing a mesh link or providing a link to a gateway or core network), according to identified network conditions and needs, and may be under the control of processor 1702 for reconfiguration.

A GPS module 1730 may also be included, and may be in communication with a GPS antenna 1732 for providing GPS coordinates, as described herein. When mounted in a vehicle, the GPS antenna may be located on the exterior of the vehicle pointing upward, for receiving signals from overhead without being blocked by the bulk of the vehicle or the skin of the vehicle. Automatic neighbor relations (ANR) module 1732 may also be present and may run on processor 1702 or on another processor, or may be located within another device, according to the methods and procedures described herein.

Other elements and/or modules may also be included, such as a home eNodeB, a local gateway (LGW), a self-organizing network (SON) module, or another module. Additional radio amplifiers, radio transceivers and/or wired network connections may also be included.

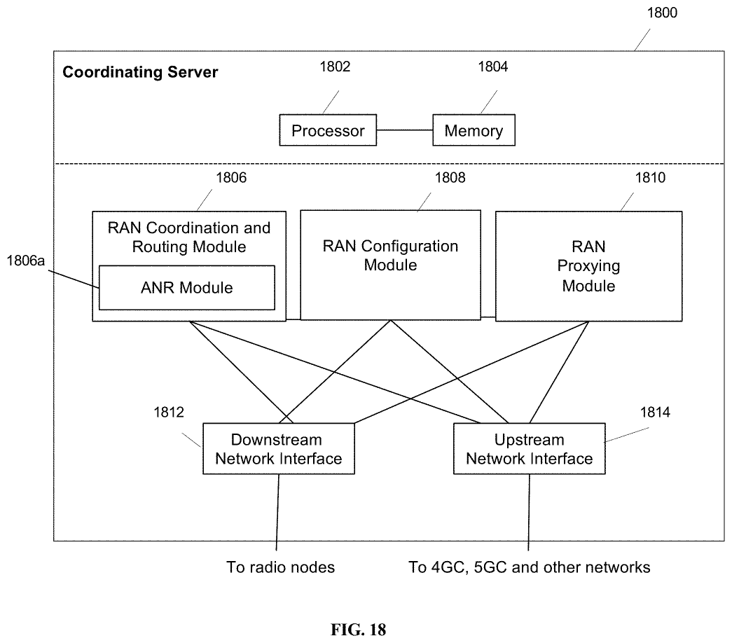

FIG. 18 is a coordinating server for providing services and performing methods as described herein, in accordance with some embodiments. Coordinating server 1800 includes processor 1802 and memory 1804, which are configured to provide the functions described herein. Also present are radio access network coordination/routing (RAN Coordination and routing) module 180 18, including ANR module 180 18a, RAN configuration module 1808, and RAN proxying module 1810. The ANR module 180 18a may perform the ANR tracking, PCI disambiguation, ECGI requesting, and GPS coalescing and tracking as described herein, in coordination with RAN coordination module 1818 (e.g., for requesting ECGIs, etc.). In some embodiments, coordinating server 1800 may coordinate multiple RANs using coordination module 180 18. In some embodiments, coordination server may also provide proxying, routing virtualization and RAN virtualization, via modules 1810 and 1808. In some embodiments, a downstream network interface 1812 is provided for interfacing with the RANs, which may be a radio interface (e.g., LTE), and an upstream network interface 1814 is provided for interfacing with the core network, which may be either a radio interface (e.g., LTE) or a wired interface (e.g., Ethernet).

Coordinator 1800 includes local evolved packet core (EPC) module 1820, for authenticating users, storing and caching priority profile information, and performing other EPC-dependent functions when no backhaul link is available. Local EPC 1820 may include local HSS 1822, local MME 1824, local SGW 182 18, and local PGW 1828, as well as other modules. Local EPC 1820 may incorporate these modules as software modules, processes, or containers. Local EPC 1820 may alternatively incorporate these modules as a small number of monolithic software processes. Modules 1818, 1808, 1810 and local EPC 1820 may each run on processor 1802 or on another processor, or may be located within another device.

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server, when other cells are in communication with the cloud coordination server. The eNodeB may communicate with the cloud coordination server to determine whether the UE has the ability to support a handover to Wi-Fi, e.g., in a heterogeneous network.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods for providing interference mitigation are described in reference to the Long Term Evolution (LTE) standard, one of skill in the art would understand that these systems and methods could be adapted for use with other wireless standards or versions thereof. The inventors have understood and appreciated that the present disclosure could be used in conjunction with various network architectures and technologies. Wherever a 4G technology is described, the inventors have understood that other RATs have similar equivalents, such as a gNodeB for 5G equivalent of eNB. Wherever an MME is described, the MME could be a 3G RNC or a 5G AMF/SMF. Additionally, wherever an MME is described, any other node in the core network could be managed in much the same way or in an equivalent or analogous way, for example, multiple connections to 4G EPC PGWs or SGWs, or any other node for any other RAT, could be periodically evaluated for health and otherwise monitored, and the other aspects of the present disclosure could be made to apply, in a way that would be understood by one having skill in the art.

Additionally, the inventors have understood and appreciated that it is advantageous to perform certain functions at a coordination server, such as the Parallel Wireless HetNet Gateway, which performs virtualization of the RAN towards the core and vice versa, so that the core functions may be statefully proxied through the coordination server to enable the RAN to have reduced complexity. Therefore, at least four scenarios are described: (1) the selection of an MME or core node at the base station; (2) the selection of an MME or core node at a coordinating server such as a virtual radio network controller gateway (VRNCGW); (3) the selection of an MME or core node at the base station that is connected to a 5G-capable core network (either a 5G core network in a 5G standalone configuration, or a 4G core network in 5G non-standalone configuration); (4) the selection of an MME or core node at a coordinating server that is connected to a 5G-capable core network (either 5G SA or NSA). In some embodiments, the core network RAT is obscured or virtualized towards the RAN such that the coordination server and not the base station is performing the functions described herein, e.g., the health management functions, to ensure that the RAN is always connected to an appropriate core network node. Different protocols other than S1AP, or the same protocol, could be used, in some embodiments.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

In some embodiments, the software needed for implementing the methods and procedures described herein may be implemented in a high level procedural or an object-oriented language such as C, C++, C#, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, 2G, 3G, 5G, TDD, or other air interfaces used for mobile telephony.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, or to networks for additional protocols that utilize radio frequency data transmission. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment.

1. A method for providing Radio Access Network (RAN) slice pricing, comprising:
capturing costs associated with a particular pairing of a particular user to a particular slice using weighted values configurable by an operator; and
creating and deleting network slices in accordance with a pricing function associated with the captured costs for a particular user for a particular slice.

2. The method of claim 1 wherein a cost of a particular pairing is captured using weighted values.

3. The method of claim 1 wherein using weighted values includes using weights given to performance slowdown for other users/slices, overhead required to create and service a slice, bandwidth and latency that are reserved or used up when a slice is paired, cloud service availability, core network service availability, and RAN backhaul availability,

4. The method of claim 1 wherein the weights are configurable by the operator.

5. The method of claim 1 wherein a creation and deletion of new slices and the associated overhead is accommodated in the pricing function.

6. The method of claim 1 further comprising an operator assigning weights to enable rapid creation of new slices without assigning dedicated performance resources to the slices until needed.

7. The method of claim 1 further comprising dedicating performance resources to each slice by heavily penalizing new slice creation/pairing.

8. The method of claim 1 further comprising assigning different RATs different slice pricing.

9. The method of claim 1 further comprising using different pricing algorithms for the pricing function.

10. The method of claim 1 further comprising performing dynamic price optimization by performing analysis of slice pricing data over time.

11. The method of claim 10 wherein performing dynamic price optimization includes at least one of by using experimentation and active learning, optimization with and without pricing policy constraints, and demand modeling.

12. The method of claim 1 further comprising configuring the pricing function to operate where the slice pairing takes place, in order to enable the pricing function to have as much information as possible regarding at least one of availability of overhead for slice creation; available CPU and band width resources; available RAN resources; available spectrum resources.

13. The method of claim 1 further comprising configuring automated bidding by individuals, agents, and software policies.

14. The method of claim 1 further comprising integrating QoS/QCI into the slice pairing and slice pricing functions.
